(19) United States
(12) Patent Application Publication
(10) Pub. No.: US 2014/0169757 A1
(43) Pub. Date: Jun. 19, 2014

(54) METHOD FOR QUICKLY DETERMINING A COMPRESSION FORMAT OF AN AUDIO OR VIDEO FILE AND RELATED PLAYBACK DEVICE THEREOF

(71) Applicant: AMTRAN TECHNOLOGY CO., LTD, New Taipei City (TW)

(72) Inventors: Kuang-Cheng Chao, New Taipei City (TW); Chih-Hao Chen, New Taipei City (TW)

(73) Assignee: AMTRAN TECHNOLOGY CO., LTD, New Taipei City (TW)

(21) Appl. No.: 13/849,541

(22) Filed: Mar. 24, 2013

(30) Foreign Application Priority Data
Dec. 13, 2012 (TW) 101147247

(51) Int. Cl. H04N 9/87; G11B 27/10

(52) U.S. Cl. CPC H04N 9/87; G11B 27/10
USPC 386/241

(57) ABSTRACT

A method for quickly determining a compression format of an audio-video file by a playback device, where the playback device includes a receiver, a detector, a register, and a processor, is disclosed. The method includes receiving an audio-video file by the receiver; using the detector to detect whether a tag portion exists behind a header of the audio-video file; using the processor to skip the tag portion to set a starting point for loading the audio-video file when the detector detects the tag portion; using the processor to filter out audio-video compression formats not compatible with the tag portion; and using the processor to load a first part to the buffer from the starting point, and determine a compression format of the audio-video file according to the first part.

### BACKGROUND OF THE INVENTION

1. Field of the Invention

The present invention relates to a method for quickly determining a compression format of an audio-video file and a related playback device thereof, and particularly to a method for quickly determining a compression format of an audio-video file according to the format of the tag portion and a related playback device thereof that skips at least one tag portion existing behind a header of the audio-video file.

2. Description of the Prior Art

In multimedia technology field, various manufactures develop many different audio-video compression techniques applied to different formats for audio-video files. Therefore, audio-video playback software needs to support each audio-video file format as far as possible nowadays. For example, open source playback software FFmpeg is well-known audio-video playback software for supporting tens of different audio-video file formats. After a user utilizes audio-video playback software to playback an audio-video file, a processor starts to load a first part of the audio-video file from a header of the audio-video file to a buffer. Then, the processor can determine the compression format of the audio-video file according to the first part of the audio-video file stored in the buffer. During determination process executed by the processor, the processor compares supported audio-video compression formats with the first part of the audio-video file stored in the buffer in a trial and error manner to find out a matching format. If the processor can not find out any matching format during the trial and error process, the processor will increase the space of the buffer used to storing data of the audio-video file, then load a second part of the audio-video file from the end of the first part of the audio-video file to the buffer, and then compares the supported audio-video compression formats with the first part and the second part of the audio-video file stored in the buffer in trial and error way to determine the compression format of the audio-video file. Thus, the processor can repeatedly execute the above mentioned steps until the processor finds the matching audio-video compression format.

However, a tag portion (e.g. an ID3v2 tag or an APE tag) may be included in the header of some audio-video files and inserted a picture or other information. When a tag portion in the header of an audio-video file is inserted an auxiliary picture or other information, the picture or information may be large data occupying much space of the buffer and blocking the loading of the data behind the header of the header, and the processor cannot directly determines the compression format of the audio-video file from the picture or information in tag portion. Therefore, during the process of determining the compression format of the audio-video file, the processor may need to execute loading and determination steps many times, and increase space of the buffer each time when the processor loads more parts of the audio-video file until the parts stored in the buffer covers the tag portion and the data behind the tag portion in the audio-video file. That is to say, only after the tag portion and following data of the audio-video file behind the tag portion are stored in the buffer, the processor can determine the correct compression format of the audio-video file based on the following data of the audio-video file behind the tag portion. Therefore, the method provided by the prior art for determining a compression format of an audio-video file can make a system spend much time and space of the buffer on completing determination process of the compression format of the audio-video file.

### SUMMARY OF THE INVENTION

An embodiment provides a method for a playback device quickly determining a compression format of an audio-video file, where the playback device includes a receiver, a detector, a register, and a processor. The method includes receiving an audio-video file by the receiver; using the detector to detect whether a tag portion exists behind a header of the audio-video file; using the processor to skip the tag portion to set a starting point of the audio-video file for loading the audio-video file when the detector detects the tag portion; using the processor to filter out audio-video compression formats not compatible with the tag portion; and using the processor to loading a first part of the audio-video file to the register from the starting point, and determine a compression format of the audio-video file according to the first part.

Another embodiment provides a method for quickly determining a compression format of an audio-video file by a playback device, where the playback device includes a receiver, a detector, a register, and a processor. The method includes receiving an audio-video file by the receiver; using the detector to detect whether a tag portion exists behind a header of the audio-video file; using the processor to set a starting point of the audio-video file for loading the audio-video file when the detector does not detect the tag portion; using the processor to skip the tag portion to set the starting point of the audio-video file for loading the audio-video file when the detector detects the tag portion; using the processor to set buffer space of the register according to an predetermined size; using the processor to load a first part of the audio-video file from the starting point of the audio-video file to the buffer according to the buffer space; and using the processor to determine a compression format of the audio-video file according to the first part.

Another embodiment provides a playback device for quickly determining a compression format of an audio-video file. The playback device includes a register, a receiver, a detector, and a processor. The register has a maximum space. The receiver is used for receiving an audio-video file. The detector is used for detecting whether a tag portion exists behind a header of the audio-video file. The processor is used for setting buffer space of the register, where when the detector detects the tag portion, the processor filters out audio-video compression formats not compatible with the tag portion according to the tag portion, and skips the tag portion to set a starting point of the audio-video file for loading the audio-video file.

The present invention provides a method for quickly determining a compression format of an audio-video file by a playback device and a related playback device thereof. The method and the playback device utilize a detector to detect whether a tag portion exists behind a header of an audio-video file. When the detector detects at least one tag portion existing in the audio-video file, a processor can skip each of the at least one tag portion to set a starting point of the audio-video file for comparing data of the audio-video file, and exclude compression formats not supporting the at least one tag portion according to the at least one tag portion included in the audio-video file to quickly determine a compression format of the audio-video file. Therefore, compared to the prior art, when the processor determines the compression format of the audio-video file, the processor can skip each of the at least one tag portion included in the audio-video file, and exclude the compression formats not supporting the at least one tag portion included in the audio-video file according to the compression formats supporting the at least one tag portion included in the audio-video file to reduce comparison number executed by the processor, so the present invention can reduce the comparison number to increase compression format determination efficiency of the processor to overcome disadvantages of the prior art.

These and other objectives of the present invention will no doubt become obvious to those of ordinary skill in the art after loading the following detailed description of the preferred embodiment that is illustrated in the various figures and drawings.

### BRIEF DESCRIPTION OF THE DRAWINGS

FIG. 1 is a diagram illustrating a playback device for quickly determining a compression format of an audio-video file according to an embodiment.

FIG. 2 is a diagram illustrating a data structure of the audio-video file including the ID3v2 tag.

FIG. 3 is a diagram illustrating a data structure of the audio-video file including the APE tag.

FIG. 4 is a flowchart illustrating a method for a playback device quickly determining a compression format of an audio-video file according to another embodiment.

### DETAILED DESCRIPTION

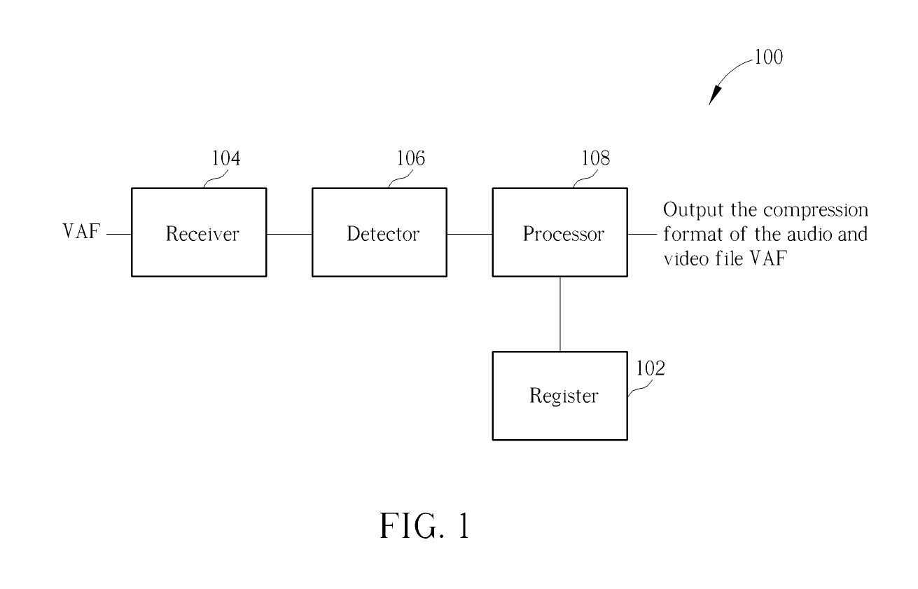

Please refer to FIG. 1. FIG. 1 is a diagram illustrating a playback device 100 for quickly determining a compression format of an audio-video file according to an embodiment of the present invention. The playback device 100 includes a register 102, a receiver 104, a detector 106, and a processor 108, where buffer space of the register 102 can be defined as variable size, and the register 102 has maximum space (e.g. 2²⁰ bytes). As shown in FIG. 1, the receiver 104 is used for receiving an audio-video file VAF. After the receiver 104 receives the audio-video file VAF, the detector 106 detects a tag (e.g. an ID3v2 tag, an APE tag, or other tags) portion exists behind the header of the audio-video file VAF. When the detector 106 detects the tag portion exists behind the header of the audio-video file VAF, the processor 108 can skip the tag portion of the audio-video file VAF before loading data of the audio-video file VAF in order to determine a compression format of the audio-video file VAF according to the data behind the tag portion, and the processor can filter out audio-video compression formats not compatible with the tag portion to quickly determine the compression format of the audio-video file VAF. For example, when the detector 106 detects an ID3v2 version 2 (ID3v2) tag exists behind the header of the audio-video file VAF, the processor 108 can skip the ID3v2 tag before loading data of the audio-video file VAF, and can filter out audio-video compression formats not compatible with the ID3v2 tag before try and error process. Because only OpenMG format and Moving Picture Experts Group Audio Layer III (MP3) format support the ID3v2 tag presently, the processor 108 can filter out other compression formats and only determine whether the compression format of the audio-video file VAF is OpenMG format or MP3 format, so there is no need to try all tens of file formats supported by the playback software or device for determination. Except the ID3v2 tag, other tag formats can be also utilized to filter out audio-video compression formats not compatible with the tag formats in order to quickly determine the compression format of the audio-video file VAF. For example, if the processor 108 detects the APE tag existing, the processor 108 can filter out audio-video compression formats except the MP3 format, WavPack format, and OptimFROG format. In addition, in another embodiment of the present invention, the processor 108 can select a plurality of possible compression formats as candidate formats for determination according to the tag. Then, when the processor 108 determines the compression format of the audio-video file VAF, the processor 108 can score the candidates and determine the compression format of the audio-video file VAF according to the scoring result of the candidates. The scoring method can prevent from the processor 108 not correctly determining the compression format of the audio-video file VAF by try and error due to incompatible tags being included in the audio-video file VAF in some specific conditions.

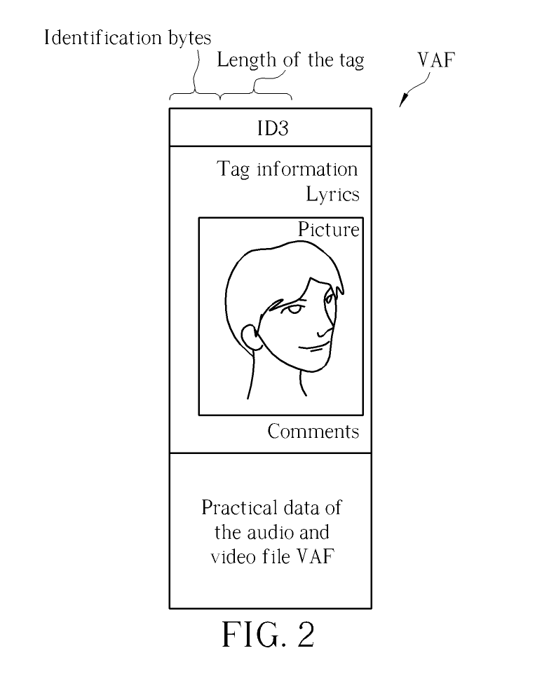

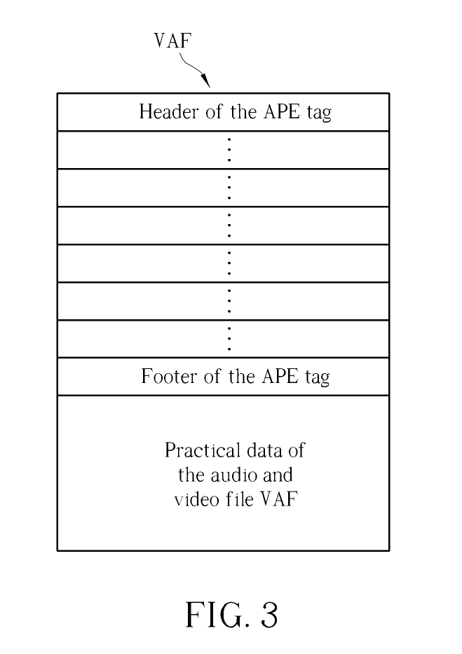

Please refer to FIG. 2 and FIG. 3. FIG. 2 is a diagram illustrating data structure of the audio-video file VAF including the ID3v2 tag and FIG. 3 is a diagram illustrating data structure of the audio-video file VAF including the APE tag. As shown in FIG. 2, the ID3v2 tag may include tag information, lyrics, pictures, or comments corresponding to the audio-video file VAF, but the processor 108 can not utilize the tag information, the lyrics, the pictures, or the comments to determine the compression format of the audio-video file VAF. It is noted that the first three (0, 1, 2) bytes of the ID3v2 tag are utilized to mark “ID3v2” and the 6^{th}, the 7^{th}, the 8^{th}, and the 9^{th} bytes of the ID3v2 tag are utilized to represent length of the ID3v2 tag. Therefore, in order to skip the ID3v2 tag, when the detector 106 detects the ID3v2 tag (according to the first three (0^{th}, 1^{st}, 2^{nd}) bytes of the ID3v2 tag) exists behind the header of audio-video file VAF, the processor 108 skips the whole ID3v2 tag according to the length of the ID3v2 tag represented by the 6^{th}, the 7^{th}, the 8^{th}, and the 9^{th} bytes of the ID3v2 tag, and load practical data of the audio-video file VAF behind the tag portion if the audio-video file VAF only includes the ID3v2 tag. In addition, as shown in FIG. 3, the APE tag has at least one footer and at least one header, where the first 8 (0^{th}-7^{th}) bytes of the footer and the header are utilized to mark “APETAGEX” and the 12^{th}, the 13^{th}, the 14^{th}, and the 15^{th} bytes of the APE tag are utilized to represent length of the APE tag excluding the header of the APE tag. Therefore, the detector 106 can detect the APE tag according to the first 8 (0^{th}-7^{th}) bytes of the APE tag, and the processor 108 can skip the APE tag according to the length of the APE tag represented by the 12^{th}, the 13^{th}, the 14^{th}, the 15^{th} bytes of the APE tag, and load practical data of the audio-video file VAF if the audio-video file VAF only includes the APE tag.

If the detector 106 detects a tag portion existing behind the header of the audio-video file VAF, the processor 108 can skip the tag portion according to length of the tag portion and filter out audio-video compression formats not compatible with the tag portion. Then, the processor 108 can initialize the register 102 to set the a buffer space according to a predetermined size (e.g. 2¹¹ bytes), and the processor 108 starts to load a first part of the audio-video file VAF from the end of the tag portion into the buffer space of the register 102, where the size of the first part is equal to the predetermined size. For example, if the audio-video file VAF only has the ID3v2 tag and the length of the ID3v2 tag is 2K Bytes, the processor 108 can skip 2K Bytes of the audio-video file VAF corresponding behind the header of the audio-video file VAF, and start to load data of the audio-video file VAF into the buffer space of the register 102 according to the buffer space, where the data of the audio-video file VAF stored in the buffer space are the first part of the audio-video file VAF utilized for format determination. After the processor 108 loads the first part of the audio-video file VAF into the buffer space of the register 102 according to the predetermined buffer space, the processor 108 can find all candidate formats compatible with the format of the detected tag and determine whether the first part of the audio-video file VAF matches a specific format among all candidate formats compatible with the detected tag. If the detector 106 detects more than one tags included in the audio-video file VAF, the processor 108 can find candidate formats which are simultaneously compatible with all the detected tags and determine whether the audio-video file VAF matches a specific candidate format among all candidate formats compatible with all the detected tag. For example, if the audio-video file VAF only has an ID3v2 tag, the processor 108 can regard the oma format and the mp3 format as candidate formats because only the oma format and the mp3 format can support the ID3v2 tag presently and determine whether the audio-video file VAF matches one of the two candidate formats, i.e., the format of VAF audio-video file is either the oma format or the mp3 format. If the audio-video file VAF has the ID3v2 tag and the APE tag, the processor 108 can firstly determine whether the audio-video file VAF matches the mp3 format because only the mp3 format is simultaneously compatible with the ID3v2 tag and the APE tag presently.

When the processor 108 determines that the first part of the audio-video file VAF does not match any candidate format, or cannot determine based on the first part of the audio-video file VAF, the processor 108 can increase the buffer space to load more data of the audio-video file VAF. For example, when the processor 108 determines that the first part of an audio-video file VAF having an ID3v2 tag does not match the two candidate formats, i.e., the oma format and the mp3 format, the processor 108 increases the buffer space, e.g. the processor 108 can double the buffer space from 2¹¹ bytes to 2¹² bytes. If the doubled buffer space does not exceed the maximum space of the register 102, e.g. 2²⁰ bytes, the processor 108 will load a second part of the audio-video file VAF to the buffer space of the register 102 according to the doubled buffer space, where the second part of the audio-video file VAF is behind the first part of the audio-video file VAF, and the size of the second part is equal to the first part of the audio-video file VAF in this case. After the processor 108 loads the second part of the audio-video file VAF to the buffer space of the register 102 according to the doubled buffer space, the processor 108 can determine whether the first part and the second part of the audio-video file VAF match one of the candidate formats (that is, one of the oma compression format and the mp3 compression format) again according to the two candidate formats compatible with the ID3v2 tag. Thus, the above mentioned steps can be repeated until the processor 108 determines that the audio-video file VAF matches one of the candidate formats, still cannot determine that the audio-video file VAF matches any of the candidate formats when the whole audio-video file VAF is completely loaded, or the maximum space of the register 102 is insufficient for the increased buffer space to load more data of the audio-video file VAF.

In addition, if the detector 106 does not detect any tag within the audio-video file VAF, the processor 108 can set the buffer space of the register 102 according to the predetermined size (e.g. 2¹¹ bytes). Then, the processor 108 starts to load a first part started behind the tag portion of the audio-video file VAF, whose size is equal to the initial predetermined size, into the buffer space of the register 102 according to the buffer space. After the processor 108 loads the first part of the audio-video file VAF into the buffer space of the register 102, the processor 108 determines whether the audio-video file VAF matches one of the compression formats supported by the playback software or the playback device 100. When the processor 108 determines that the audio-video file VAF does not match any of the compression formats supported by the playback program, the processor 108 can increase the buffer space and load more data of the audio-video file VAF again to further determination. For example, when the processor 108 determines that audio-video file VAF does not match the compression formats supported by the playback software, the processor 108 increases the buffer space, e.g. the processor 108 doubles the buffer space from 2¹¹ bytes to 2¹² bytes. When the doubled buffer space does not exceed the maximum space of the register 102, e.g. 2²⁰ bytes, the processor 108 will load a second part of the audio-video file VAF to the buffer space of the register 102 according to the doubled buffer space, where the second part of the audio-video file VAF is behind the first part of the audio-video file VAF and the size of the second part is equal to the first part in this case. After the processor 108 loads the second part of the audio-video file VAF to the buffer space of the register 102 according to the doubled buffer space, the processor 108 can determine whether the first part and the second part of the audio-video file VAF match one of the compression formats supported by the playback software again. Thus, the processor 108 can repeat the above mentioned steps until the processor 108 determines that the audio-video file VAF matches one of the compression formats supported by the playback software, still cannot determine that the audio-video file VAF matches any of the compression formats supported by the playback program when the whole audio-video file VAF is completely loaded, or the maximum space of the register 102 is insufficient to load more data of the audio-video file VAF.

In addition, in another embodiment of the present invention, when the audio-video file VAF only has the APE tag or has both the ID3v2 tag and the APE tag, the playback device 100 can also utilize the above mentioned steps to quickly determine the compression format of the audio-video file VAF, so further description thereof is omitted for simplicity. In addition, the method of the present invention can also be applied to quickly determine the compression format of the audio-video file VAF with other types of tags, that is, the present invention is not limited to the above mentioned descriptions corresponding to the ID3v2 tag and the APE tag.

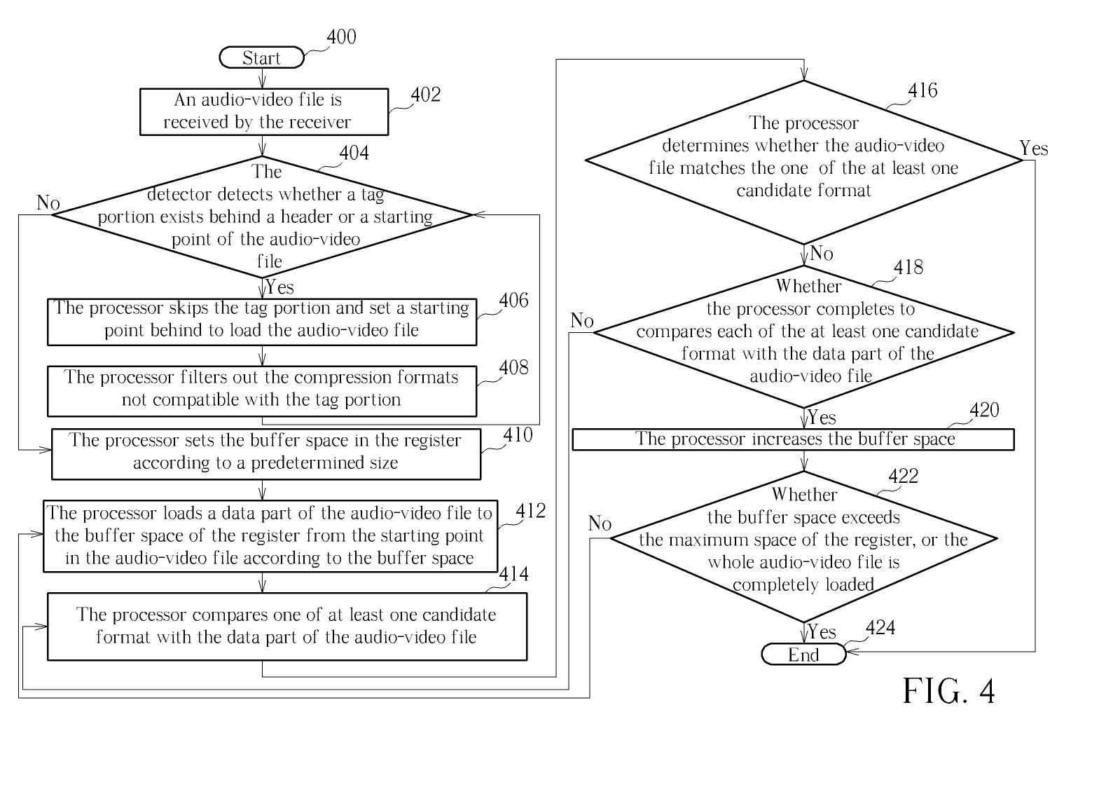

Please refer to FIG. 1, FIG. 2, FIG. 3, and FIG. 4. FIG. 4 is a flowchart illustrating a method for a playback device quickly determining a compression format of an audio-video file according to another embodiment. The method in FIG. 4 is illustrated using the playback device 100 in FIG. 1. Detailed steps are as follows:

Step 400: Start.

Step 402: An audio-video file VAF is received by the receiver 104.

Step 404: The detector 106 detects whether a tag portion exists behind a header or a starting point of the audio-video file VAF; if yes, go to Step 406; if no, go to Step 410.

Step 406: The processor 108 skips the tag portion and set a starting point behind to load the audio-video file VAF.

Step 408: The processor 108 filters out the compression formats not compatible with the tag portion, go to Step 404.

Step 410: The processor 108 sets the buffer space in the register 102 according to a predetermined size.

Step 412: The processor 108 loads a data part of the audio-video file VAF to the buffer space of the register 102 from the starting point in the audio-video file VAF according to the buffer space.

Step 414: The processor 108 compares one of at least one candidate format with the data part of the audio-video file VAF.

Step 416: The processor 108 determines whether the audio-video file matches the one of the at least one candidate format; if no, go to Step 418; if yes, go to Step 424.

Step 418: Whether the processor 108 completes to compares each of the at least one candidate format with the data part of the audio-video file VAF; if no, go to Step 414; if yes, go to Step 420.

Step 420: The processor 108 increases the buffer space.

Step 422: Whether the buffer space exceeds the maximum space of the register 102, or the whole audio-video file VAF is completely loaded; if no, go to Step 412; if yes, go to Step 424.

Step 424: End.

In Step 404, after the receiver 104 receives the audio-video file VAF, the detector 106 detects whether at least one tag portion, e.g. the ID3v2 tag, the APE tag, or other tags, exists behind the header of the audio-video file VAF.

Take FIG. 2 as an example. In Step 406 and Step 408, when the detector 106 detects at least one tag portion existing behind the header of the audio-video file VAF, the processor 108 can skip the at least one tag portion, set the starting point to load the audio-video file VAF behind the at least one tag portion, and filter out the compression formats not compatible with the at least one tag portion. For example, when the detector 106 detects the ID3v2 tag existing behind the header of the audio-video file VAF, the processor 108 can skip the whole ID3v2 tag according to length information included in the ID3v2 tag, set the starting point to load the audio-video file VAF at the end of the ID3v2 tag, and filter out compression formats not compatible with the ID3v2 tag from all compression formats supported by the playback software or the playback device 100, i.e., the processor 108 can filter out all compression formats supported by the playback software or device except the oma format and the mp3 format. In Step 410, if the detector 106 detects the tag portion existing behind the header of the audio-video file VAF, the processor 108 sets the buffer space of the register 102 according to the predetermined size, e.g. 2¹¹ bytes, after the processor 108 skips the tag portion, sets the starting point to load the audio-video file VAF and filters out the compression format not compatible with the tag portion. Then, in Step 412, the processor 108 loads the first part of the audio-video file VAF started behind the tag portion to the buffer space of the register 102 according to the predetermined size. For example, if the audio-video file VAF only has the ID3v2 tag and the length of the ID3v2 tag is 2K Bytes, in Step 410, the processor 108 will skip 2K Bytes, corresponding to the ID3v2 tag, of the audio-video file VAF to set the starting point at the end of the ID3v2 tag, and in Step 412, the processor 108 loads the first part started from the starting point of the audio-video file VAF to the buffer space of the register 102 according to the buffer space. In Step 414, the processor 108 regards compression formats compatible with the tag portion as candidate formats, and selects one of the candidate formats to be compared with the first part. If the processor 108 determines that the audio-video file VAF has at least one tag portion, the processor 108 can compare one of the candidate formats, which include only the formats compatible with the detected tag after Step 408, with the first part of the audio-video file VAF. In Step 416, the processor 108 determines whether the audio-video file VAF matches the compared candidate format according to a determination result. For example, if the audio-video file VAF only has an ID3v2 tag, and only the oma format and the mp3 format are compatible with the ID3v2 tag presently, the processor 108 can select one of the oma format and the mp3 format to be compared with the first part firstly in order to determine whether the first part of the audio-video file VAF matches the candidate format. In Step 418, if the determination result in Step 416 shows that the first part does not match the selected candidate format, the processor 108 determines whether all candidate formats are already compared with the first part. If not yet, the processor 108 returns to Step 414 to select another one of the at least one candidate format, which is not compared with the first part yet, to be compared with the first part until the processor 108 finds the matched candidate format, or all candidate formats are already compared with the first part. In Step 420, when the processor 108 determines that the first part of the audio-video file VAF does not match any of the at least one candidate format, the processor 108 increases the buffer space. For example, if the audio-video file has an ID3v2 tag and the processor 108 cannot find any of the two candidate formats compatible with the ID3v2 tag matching the first part of the audio-video file VAF, the processor 108 increases the buffer space in the register 102, e.g. the buffer space is doubled from 2¹¹ bytes to 2¹² bytes. In Step 422, the processor 108 determines whether the increased buffer space exceeds the maximum space of the register 102. If the increased buffer space does not exceed the maximum space of the register 102, and the audio-video file VAF is not completely loaded yet, the processor 108 returns to Step 412 and loads the second part of the audio-video file VAF to the buffer space of the register 102 according to the increased buffer space, where the second part of the audio-video file VAF is started to load behind the first part of the audio-video file VAF. After the processor 108 loads the second part of the audio-video file VAF to the buffer space of the register 102, the processor 108 can repeat the above mentioned steps until the processor 108 determines that the audio-video file VAF matches one of the at least one candidate format, the processor 108 still cannot determine that the audio-video file VAF matches one of the at least one candidate format when the whole audio-video file VAF is completely loaded, or the maximum space of the register 102 is insufficient for the increased buffer space to load more data of the audio-video file VAF.

In addition, in Step 410, if the detector 106 does not detect any tag portion existing behind the header of the audio-video file VAF, the processor 108 can set the buffer space according to the predetermined size, e.g. 2¹¹ bytes. In Step 412, the processor 108 starts to load the first part of the audio-video file VAF started behind the tag portion to the buffer space of the register 102 according to the buffer space. In Step 414 and Step 416, the processor 108 regards compression formats supported by the playback software or the playback device 100 as candidate formats, and compares one of the candidate formats with the first part of the audio-video file VAF to determine whether the audio-video file VAF matches the candidate format. In Step 418, if the determination result in Step 416 shows that the first part does not match the candidate format, the processor 108 determines whether all of the compression formats supported by the playback program are completely compared with the first part. If any of the candidate formats is still not compared with the first part, the processor 108 returns to Step 414 to select another candidate format not compared with the first part to be compared with the first part until the processor 108 finds out one matching candidate format, or all of the candidate formats are completely compared with the first part. In Step 420, when the processor 108 determines that the first part of the audio-video file VAF does not match any of the candidate formats, the processor 108 increases the buffer space. For example, after the processor 108 completes to compare all of the candidate formats and determines that the first part of the audio-video file VAF does not match any of the candidate formats, the processor 108 doubles the buffer space, e.g. the buffer space is increased from 2¹¹ bytes to 2¹² bytes. In Step 422, when the increased buffer space does not exceed the maximum space of the register 102, and the audio-video file VAF is not completely loaded, the processor 108 returns to Step 412 and loads the second part of the audio-video file VAF to the buffer space of the register 102 according to the increased buffer space. After the processor 108 loads the second part of the audio-video file VAF to the buffer space of the register 102, the processor 108 can repeat the above mentioned steps until the processor 108 determines that the audio-video file VAF matches one of the candidate formats, the processor 108 still cannot determine that the audio-video file VAF matches any of the candidate formats when the whole audio-video file VAF is completely loaded, or the maximum space of the register 102 is insufficient for the increased buffer space to load more data of the audio-video file VAF.

In addition, in another embodiment of the present invention, when the audio-video file VAF only has the APE tag or has both the ID3v2 tag and the APE tag, the playback device 100 can also utilize the above mentioned steps to quickly determine the compression format of the audio-video file VAF, so further description thereof is omitted for simplicity. Moreover, the method of the present invention can also quickly determine the compression format of the audio-video file VAF with other types of tags, that is, the present invention is not limited by the above mentioned descriptions.

In one embodiment of the present invention, the processor 108 can select a plurality of candidate formats according to information corresponding to each tag portion included in the audio-video file VAF, where the plurality of candidate formats are not limited to the compression formats supported by the playback software. When the processor 108 finds out that the format of the audio-video file VAF may be not supported by the playback software, the processor 108 can notify the user to update the playback software to support the compression format, or a system can update the playback software automatically. In addition, in one embodiment of the present invention, the processor 108 can regard the all compression formats supported by the playback software or the playback device 100 as candidate formats, that is, the candidate formats are not limited to compression formats compatible with the tag portion or tags included in the audio-video file VAF. It is meant that the processor 108 does not filter out the compression formats 106 not compatible with the tags detected by the detector in Step 408. Then, in Step 414 to Step 418, the processor 108 compares the first part of the audio-video file with the candidate formats to score the candidate formats, and excludes candidate formats having scores lower than a threshold value based on the scoring results. If all scores of the candidate formats are lower than the threshold value, the processor 108 can repeat Step 414 to Step 418 to score the candidate formats again. In Step 408, the processor 108 can also not filter out compression formats detected by the detector 106 not supporting the tags, and set priority order of the compression formats detected by the detector 106 supporting the tags. In Step 414 to Step 418, the processor 108 can firstly compare the compression formats compatible with the tag or tags detected by the detector 106 with the first part of the audio-video file VAF in order to score the compression formats compatible with the tag or tags. If any scoring result is higher than the threshold value, the processor 108 determines that the format of the audio-video file VAF is the compression format with the scoring result. In addition, the playback device 100 of the present invention is not limited to FIG. 1, where the detector 106 can also be a part of the processor 108, or a function executed by the firmware or program of the processor 108. Moreover, the receiver 104 or the register 102 can be also integrated with other devices and not limited to the above mentioned descriptions.

In summary, the present invention provides the method for quickly determining a compression format of an audio-video file and the related playback device thereof. The method and the playback device utilize the detector to detect whether a tag portion exists behind the header of the audio-video file. When the detector detects at least one tag portion existing in the audio-video file, the processor can skip the at least one tag portion and set a starting point to load the data in the audio-video file for comparison, and exclude the compression formats not compatible with the at least one tag portion detected in the audio-video file. Therefore, compared to the prior art, when the processor determines the compression format of the audio-video file, the processor can skip each of the at least one tag portion included in the audio-video file, and exclude the compression formats not compatible with the at least one tag portion included in the audio-video file, so the complexity of the comparison work to find the correct format of the audio-video file is reduced in the present invention, and the efficiency of the playback software and device is improved in order to overcome disadvantages of the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for quickly determining a compression format of an audio-video file by a playback device, wherein the playback device comprises a receiver, a detector, a register, and a processor, the method comprising:
receiving an audio-video file by the receiver;
using the detector to detect whether a tag portion exists behind a header of the audio-video file;
using the processor to skip the tag portion to set a starting point of the audio-video file for loading the audio-video file when the detector detects the tag portion;
using the processor to filter out audio-video compression formats not compatible with the tag portion; and
using the processor to load a first part of the audio-video file to the register from the starting point, and determine a compression format of the audio-video file according to the first part.

2. The method of claim 1, further comprising:
using the detector to detect whether another tag portion exists behind the header of the audio-video file after the processor filters out the audio-video compression formats not compatible with the tag portion.

3. The method of claim 1, further comprising:
using the processor to set buffer space of the register according to a predetermined size;
using the processor to load the first part of the audio-video file to the buffer according to the buffer space;
using the processor to determine whether the audio-video file matches at least one candidate format corresponding to the tag portion according to the first part after the processor filters out the audio-video compression formats not compatible with the tag portion;
using the processor to increase the buffer space when the audio-video file does not match the at least one candidate format; and
using the processor to load a second part of the audio-video file to the buffer according to the increased the buffer space when the increased the buffer space does not exceed maximum space of the register, wherein the second part of the audio-video file is behind the first part of the audio-video file.

4. The method of claim 3, wherein using the processor to determine whether the audio-video file matches the at least one candidate format corresponding to the tag portion according to the first part comprises:
using the processor to compare one candidate format of the at least one candidate format with the first part of the audio-video file; and
using the processor to compare another candidate format of the at least one candidate format with the first part of the audio-video file when the candidate format does not match the first part of the audio-video file.

5. A method for quickly determining a compression format of an audio-video file by a playback device, wherein the playback device comprises a receiver, a detector, a register, and a processor, the method comprising:
receiving an audio-video file by the receiver;
using the detector to detect whether a tag portion exists behind a header of the audio-video file;
using the processor to set a starting point of the audio-video file for loading the audio-video file when the detector does not detect the tag portion;
using the processor to skip the tag portion to set the starting point of the audio-video file for loading the audio-video file when the detector detects the tag portion;
using the processor to set buffer space of the register according to a predetermined size;
using the processor to load a first part of the audio-video file from the starting point of the audio-video file to the buffer according to the buffer space; and
using the processor to determine a compression format of the audio-video file according to the first part.

6. The method of claim 5, wherein using the processor to determine the compression format of the audio-video file according to the first part comprises:
using the processor to compare one candidate format of at least one candidate format corresponding to the tag portion with the first part of the audio-video file; and
using the processor to compare another candidate format of the at least one candidate format with the first part of the audio-video file when the candidate format does not match the first part of the audio-video file.

7. The method of claim 5, further comprising:
using the processor to increase the buffer space when the audio-video file does not match at least one candidate format corresponding to the tag portion;
using the processor to load a second part of the audio-video file to the buffer according to the increased buffer space when the increased buffer space does not exceed a maximum space of the register, wherein the second part of the audio-video file is behind the first part of the audio-video file; and
using the processor to determine the compression format of the audio-video file according to the first part and the second part.

8. A playback device for quickly determining a compression format of an audio-video file, the playback device comprising:
a register having a maximum space;
a receiver for receiving an audio-video file;
a detector for detecting whether a tag portion exists behind a header of the audio-video file; and
a processor for setting buffer space of the register, wherein when the detector detects the tag portion, the processor filters out audio-video compression formats not compatible with the tag portion according to the tag portion, and skips the tag portion to set a starting point of the audio-video file for loading the audio-video file.

9. The playback device of claim 8, wherein the processor loads a first part of the audio-video file to a buffer of the register from the starting point, and determines the compression format of the audio-video file according to the first part; and when the processor does not determine the compression format of the audio-video file according to the first part, the processor increases a buffer space, loads a second part of the audio-video file to the buffer according to the increased buffer space, and determines the compression format of the audio-video file according to the first part and the second part.

10. The playback device of claim 9, wherein the processor compares data stored in the buffer with at least one candidate format according to the data stored in the buffer to score the at least one candidate format when the processor determines the compression format of the audio-video file, and the processor selects one candidate format matching the audio-video from the at least one candidate format according to a scoring result.
